(19) United States
(12) Patent Application Publication
(10) Pub. No.: US 2026/0057686 A1
(43) Pub. Date: Feb. 26, 2026

(54) METHOD FOR AUTOMATICALLY GENERATING A LABELING INSTRUCTION FOR LABELING AN IMAGE AND SYSTEM FOR EXECUTING THE METHOD

(71) Applicants: CARIAD SE, Wolfsburg (DE); Robert Bosch GmbH, Stuttgart (DE)

(72) Inventors: Daniel BAUER, Wolfsburg (DE); Hauke BRUNKEN, Wolfsburg (DE); Paola RAMOS JIMENEZ, Wolfsburg (DE); Katja LAUER, Stuttgart (DE)

(21) Appl. No.: 19/305,533

(22) Filed: Aug. 20, 2025

(30) Foreign Application Priority Data
Aug. 21, 2024 (DE) 10 2024 123 825.9

(51) Int. Cl. G06V 20/70; G06V 10/764; G06V 10/774; G06V 10/82; G06V 20/56

(52) U.S. Cl. CPC G06V 20/70; G06V 10/764; G06V 10/774; G06V 10/82; G06V 20/588

(57) ABSTRACT

The disclosure relates to a method for automatically generating a labeling instruction for at least one image by way of a system, comprising an instruction-and-labeling model. In step a), images with manual labels are passed to the instruction model. In step b), the instruction model generates labeling instructions for the images. In step c), the machine labeling model feeds these labeling instructions and automatically generates labels for the images. In step d), a reconstruction loss quantifies a discrepancy between the manual and automatic labels. In step e), the steps a) to d) are repeated until a certain number of training loops or a set reconstruction loss value is reached. If one condition from step e) is satisfied, the instruction model is applied to new images without labels from step b.2).

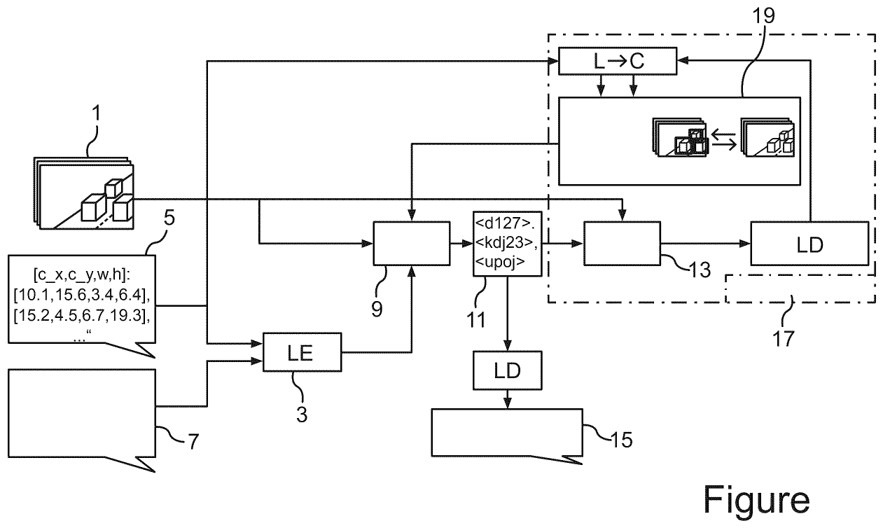

### BACKGROUND

### Technical Field

The disclosure relates to a method for automatically generating a labeling instruction for labeling an image.

### Description of the Related Art

Manually annotating or labeling is an essential process in data preparation, in particular in the area of machine learning and/or text processing and/or image processing. Annotating relates to manually adding metadata and/or a text description to raw data or real-time data such as one or multiple images, e.g., to structure them for an algorithm and/or a machine model or language model, which is in particular crucial for supervised learning.

In the last years, the automobile industry has made considerable progress in the development of driver assistance systems and/or autonomous vehicles. One of the key technologies in this area is the real-time data acquisition and processing. Up to now, real-time data has to be manually annotated afterwards, which is time consuming and/or can be prone to errors. Therefore, an automatic annotation process in real time, e.g., for recognizing lanes, is desirable, in particular to improve the efficiency of the data processing. Accordingly, a corresponding method for automatically generating a labeling instruction, in particular comprising instructions for labeling/annotating an image, would be desirable to allow automatically labeling and/or a real-time annotation.

The publication “Thinking Like an Annotator: Generation of Dataset Labeling Instructions” (Authors: Nadine Chang, Francesco Ferroni, Michael J. Tarr, Martial Hebert, Deva Ramanan. Published: 2023) discloses the generation of labeling instructions.

### BRIEF SUMMARY

The disclosure provides an improved method for automatically generating a labeling instruction.

The disclosure relates to a method for automatically generating at least one labeling instruction for labeling or annotating at least one image for at least one machine labeling model by way of a system, which comprises at least one machine instruction model or instructional vision language model and a labeling model or labeling vision language model, which are each based on pretrained machine vision language models. An intention of using at least two machine instruction models can be that they, e.g., mutually validate each other, such that an accuracy in the generation of the labeling instruction can be increased and/or an indication is output if the labeling instructions of the respective models differ from each other for a preset number of iterations. Herein, the use of large machine vision language models is in particular advantageous, which can include several million or billion (e.g., 10 million to 2 billion) of parameters, such as the “CLIP”® model of OpenAI® with 400 million of parameters or the “ALIGN” ® model with 1.5 billion of parameters. The instruction model can generate a labeling instruction for an image, which indicates how the image is to be annotated (e.g., “annotate all cyclists”). The output of an instruction model is a corresponding labeling instruction, which can be supplied to a labeling model, to instruct it to perform a corresponding annotation/labeling for the image, which results in an automatically generated label for the image (e.g., indications, which pixels of the image are a constituent of a cyclist).

The method comprises the following steps:
a) providing a plurality of (e.g., 2 to 2 million) of images, in particular images, which have been captured during a travel with a motor vehicle, e.g., by way of a camera (e.g., mounted on the front of the motor vehicle), together with associated labels, e.g., created manually or by a model-based simulation, to the instruction model. Herein, it is in particular advantageous if the plurality of the images includes multiple scenes of a scenario, thus, e.g., that the images show different perspectives, e.g., in a same environment. In other words, images are advantageous, which represent as many (e.g., 5 to 10000) situations or scenarios as possible. An associated manual label can include, e.g., one or more bounding boxes and/or object labels and/or a text description and/or segmentation masks and/or timestamps. In particular, it is provided that the images describe and/or include lanes.
b) Applying the instruction model, e.g., configured as at least one (pretrained) visual geometry group model (e.g., by way of a loop or batch processing), to the plurality of the images, whereby a labeling instruction is generated for each image.
c) Feeding the labeling instruction into the labeling model, e.g., configured as at least one transformer network, and by way of the labeling model: generating an automatically generated label for each image.
d) Applying a reconstruction loss for quantifying a discrepancy between the manual label and the label automatically generated by the labeling model, whereby a reconstruction loss value is generated, which serves as a measure of the accuracy of the automatic label.
e) Repeating the steps a) to d) until a preset number of training loops, e.g., 10 to 10000, and/or a preset reconstruction loss value (e.g., 0.05 to 1.2) is reached. In particular, the “training loop”includes the steps a) to d).
f) If one of the two or if both conditions are achieved:
   b.2) Applying the instruction model to a new plurality of images, in particular real-time images, which have been captured during a drive with the motor vehicle, e.g., by way of the camera or, e.g., a light detection and ranging camera (LiDAR camera), without associated label, whereby a labeling instruction is generated for each image. Labels may be associated with the new plurality of images, however, they are not supplied to the instruction model.
   c.2) Feeding the labeling instruction into the labeling model and by way of the labeling model: Generating an automatically generated label for each new image (of the plurality of new images),
wherein b.2) and c.2) are repeated until a termination criterion is initiated.

In other words, a plurality of images together with manually created labels can be used to train a machine instruction model. The instruction model generates a labeling instruction for each image, which indicates, how the image is to be annotated and/or what the image should include as annotated data. The labeling instruction can include that objects are to be recognized and/or designated (e.g., “recognize all cars and pedestrians”) and/or certain regions, e.g., a street, are to be segmented and/or objects are to be categorized, e.g., that vehicles are classified according to type (vehicle, motorcycle), and/or an emphasis is to be initiated, e.g., that the object is marked with a certain color.

The termination criterion can include that a preset number of iterations, e.g., 2 to 2000, have been performed and/or a preset period of time has elapsed, e.g., one hour to 100 000 hours. The termination criterion can relate to a manual termination of the method, e.g., executed by a user.

The automatically generated labels can be used to, e.g., train a component of the vehicle trained by machine, in particular to train a lane recognition network, thus a neural network, for recognizing lanes. Thereafter, the recognized lanes (in c.2) can be used to realize a lane guidance, e.g., by way of the component trained by machine and/or by way of the lane recognition network. By way of the lane recognition network, the vehicle can be controlled and/or a longitudinal and/or transverse guidance can be performed. This can be realized by way of a driving assistance system, comprising the lane recognition network. As soon as the system is trained, thus, it can be applied to new images or image data in real time, which are captured, e.g., by the camera of the vehicle.

By the disclosure, the advantage arises that labeling instructions are automatically generated without an additional label. In other words, the instruction model is trained to automatically generate labeling instructions. Thereby, the quality of the labels can additionally be improved compared to manual labels.

Developments, by which additional advantages arise, also belong to the disclosure.

A development provides that the instruction model provides an interface (e.g., as a graphic user interface) for receiving a user command. The interface can be configured to receive natural language user commands and/or include a display device for capturing manual inputs, such as for example by touchscreen and/or keyboard.

A development provides that at least one preset criterion for generating, in particular for annotating, labels is set by way of the user commands. By “preset,” it is meant that the criterion is already defined and/or implemented in the instruction model and only has to be selected. In other words, the at least one preset criterion can be incorporated into the labeling instruction and correspondingly change it. Thereby, the advantage arises that it can be influenced, what the labeling instruction is to include. Following up on that, a manual manipulation from the outside in the training of the system can be achieved in this respect. The reconstruction loss can be configured to additionally consider the user command, and calculate a discrepancy between user command and automatic labeling. Additionally or alternatively, according to the user command by way of manual post processing, it can be recognized if and to what extent it has been implemented, thus measured against the labeling instruction, which is, e.g., reproduced in natural language form, and/or based on the automatically generated label.

A development provides that the criterion that is selected includes:
at least one of multiple preset labeling methods (e.g., image labeling and/or segmentation and/or classification and/or localization and/or feature annotation and/or summary) and/or
at least one of multiple preset labeling categories (e.g., car and/or pedestrian) and/or
at least one of multiple preset labeling rules, which determine when an object is to be annotated (e.g., according to size, in particular includes at least 10 to 100 pixels in height and width, and/or speed, e.g., wherein only one object is annotated only if it exceeds a minimum speed, e.g., 10 to 100 kilometers per hour).

In that a labeling is realized according to at least one preset criterion, a resource utilization can be improved, since only one such labeling is possibly effected, which is of interest to the user (e.g., only annotate lanes), which is in particular advantageous in real-time applications or in case of limited resources.

A development provides that an indication, e.g., configured as an acoustic and/or visual and/or haptic signal, is generated for a user of the system in step a) and/or c.2). Therein, it is advantageous that the user can be incited or encouraged to perform a resource limiting (at least until step c.2 is reached).

A development provides that the plurality of the images describes lanes, wherein the label automatically generated in c.2 is routed or transmitted to a driver assistance system or the system, wherein the driver assistance system includes a lane recognition network (artificial neural network), wherein the lane recognition network is trained to recognize lanes by way of the automatically generated label, and the driver assistance system performs an at least partially automatically (at least partially automated, e.g., level 1 to level 5) realized longitudinal and/or transverse guidance according to recognized lanes by way of the trained lane recognition network.

In other words, the automatically generated labels can be used by the system or a driver assistance system for training an artificial neural network for recognizing lanes. Subsequently, a lane recognition and/or an at least partially automated longitudinal and/or transverse guidance can be performed thereby. This can reduce the demand of manual work since labeling of the lanes is effected in automated manner. This can save time and cost in the creation of training data. Furthermore, a continuous improvement of the lane recognition network can be allowed thereby.

A development provides that the associated, manual label includes a text description and/or describes position information and/or the size of a recognized object within an image (e.g., as a list of recognized boxes or bounding boxes in the form of [center_x, center_y, width, height]: [0.0, 0.1, 5.1, 6.1]). Herein, the terms can be defined as follows:
center_x: The horizontal position of the center of the box or bounding box within the image.
center_y: The vertical position of the center of the box within the image.
Width: The width of the box.
Height: The height of the box.

Thereby, the training and/or the functionality of the system can be improved since extensive information is provided, which can reduce the probability of misinterpretation.

A development provides that the instruction model provides the labeling instruction in natural language form, e.g., as text and/or as machine speech output, for the user. This allows to the user to understand contents or information of the labeling instructions (since they otherwise are present in machine code) and to perform corresponding adaptations on the system, for example by changing the images, in particular by changing a scene, and/or their associated labels.

A development provides that it is ensured by way of a data criterion that the plurality of the images together with the associated labels covers a plurality of scenarios in that a preset number of images is respectively captured at different times of day (e.g., morning and/or afternoon and/or evening) and/or under different weather conditions (e.g., sunny and/or cloudy and/or rainy and/or covered by snow) and/or with varying illumination situations (e.g., natural light and/or artificial light and/or twilight) and/or from different perspectives (e.g., frontally and/or laterally and/or obliquely). Ensuring can include that a predefined number of images, e.g., 10 to 10 000, together with manual label is to be received and/or provided to each aspect. If this should not be the case, the data criterion can signal, e.g., by a display device and/or as a natural language output, that insufficient images are provided, and/or initiate the capture of images.

A development provides that the automatically generated label includes: information to one or more recognized objects in the image, including the position and/or size of the corresponding objects. The automatically generated label can provide contents in a format, as they are found in the manual label.

Thereby, standardization of the labels and/or their contents can be achieved, whereby a comparability between manually and automatically created labels is facilitated.

The disclosure includes a control device, wherein the control device comprises a processor device, which comprises program instructions, which, upon execution by the processor device, cause it to perform a method according to any one of the preceding method claims.

A motor vehicle comprising such a control device belongs to the disclosure.

For application cases or application situations, which can arise in the method and which are not explicitly described here, it can be provided that an error message and/or a request for inputting a user feedback are output and/or a default setting and/or a predetermined initial state are adjusted according to the method.

Hereto, the processor device can comprise at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can respectively be used as the microprocessor. Furthermore, the processor device can comprise a program code, which is configured to perform the embodiment of the method according to the disclosure upon execution by the processor device. The program code can be stored in a data memory of the processor device. The processor device can be based, e.g., on at least one circuit board and/or on at least one SoC (System on Chip).

A system can belong to the disclosure, which includes a motor vehicle and a backend server device, wherein the backend server device includes the control device.

The motor vehicle according to the disclosure is preferably configured as an automobile, in particular as a passenger car or truck, or as a passenger bus or motorcycle.

As a further solution, the disclosure also includes a computer-readable storage medium including program code, which, upon execution by a computer or a computer cluster, causes it to execute an embodiment of the method according to the disclosure. The storage medium can be at least partially provided as a non-volatile data memory (e.g., as a flash memory and/or as an SSD—solid state drive) and/or at least partially as a volatile data memory (e.g., as a RAM—random access memory). The storage medium can be arranged in the computer or computer cluster. However, the storage medium can for example also be operated as a so-called Appstore server and/or Cloud server in the Internet. By the computer or computer cluster, a processor circuit with for example at least one microprocessor can be provided. The program code can be provided as a binary code and/or as an assembler code and/or as a source code of a programming language (e.g., C) and/or as a program script (e.g., Python).

The disclosure also includes the combinations of the features of the described embodiments. Thus, the disclosure also includes realizations, which each comprise a combination of the features of multiple of the described embodiments, if the embodiments have not been described as mutually exclusive.

### BRIEF DESCRIPTION OF THE SEVERAL VIEWS OF THE DRAWINGS

In the following, execution examples of the disclosure are described.

The Figure shows a schematic representation of an embodiment of the method according to the disclosure.

### DETAILED DESCRIPTION

The execution examples explained in the following are advantageous embodiments of the disclosure. In the execution examples, the described components of the embodiments each represent individual features of the disclosure to be considered independently of each other, which each also develop the disclosure independently of each other. Therefore, the disclosure also is to include combinations of the features of the embodiments different from the illustrated ones.

Furthermore, the described embodiments can also be supplemented by further ones of the already described features of the disclosure.

In the figure, identical reference characters each denote functionally identical elements.

The Figure shows one or more images 1, an interface 3, a manual label 5, a user command 7, an instruction model 9, a labeling instruction 11, a labeling model 13, a natural language labeling instruction 15, a training process 17 and a reconstruction loss 19. The interface 3, the instruction model 9, the labeling model 13 and the reconstruction loss 19 can be provided in a system. The system can include a camera and/or a LiDAR camera for capturing the images 1.

According to an embodiment, at least one image 1, preferably a plurality, together with associated, manually created labels 5 can be provided to the instruction model 9. The instruction model 9 and the labeling model 11 can be based on already pretrained machine vision language models. Then, the instruction model 9 can be applied to the plurality of the images 1, whereby a labeling instruction 11 is generated for each image 1. The labeling instruction 11 can be fed or introduced into the labeling model 13 and an automatically generated label can be generated for each image 1 by way of the labeling model 13. A reconstruction loss 19 for quantifying a discrepancy between the manual label and the label automatically generated by the labeling model (13) can be applied (to the manual label 5 and the automatically generated label), whereby a reconstruction loss value is generated, which serves as a measure of the accuracy of the automatic label. The steps a) to d) can be repeated until a preset number of training loops and/or a preset reconstruction loss value is reached. If at least one of the two conditions from step e) is achieved, the following steps can be initiated, in particular by a user during a drive in a motor vehicle, in particular for automatically labeling or annotating lanes. This in particular has the advantage that the method can be applied in the motor vehicle for real-time labeling. Thereby, it can for example be realized that lanes are recognized.

“LE” in the Figure stands for “language encoding,” thus language encoding, wherein “LD” stands for “language decoding”, thus language decoding. In “LE,” a natural language content can thus be encoded into machine-readable code, while “LD” can cause the opposite effect. By “L→C,” it is meant that the language is converted into code. Language encoding can relate to the method for representing characters and text in a certain format, which can be processed by computers. Language to code can relate to the process, in which natural language is translated into machine-readable code or programming instructions.

The instruction model 9 can be applied to a new plurality of images without associated label, whereby a labeling instruction 11 is generated for each image 1. The labeling instruction 11 can be fed into the labeling model 13 and an automatically generated label can be generated for each new image 1 by way of the labeling model 13. The steps b.2) and c.2) can be repeated until a termination criterion is initiated. In the Figure, the labeling instruction 11 (or the at least one labeling instruction 11) is exemplarily represented as “<d127>. <kdj23>, <upoj>”

It can be provided that user commands 7 are also included as training data in addition to the images 1 together with their labels. This has the advantage that the system considers the user command by way of the reconstruction loss 19 for calculating an error rate or the discrepancy.

In other words, the system can allow the generation of labeling instructions 11 from a set of manually labeled example images or images 1 with the aid of large vision language models (LVLMs) 9, 13. Thus, the system can include the following:

In particular, it is provided that a set of manually labeled images 1 captures diverse (and/or relevant) scenarios, such that the system, in particular the instruction model 9, is instructed or trained to the effect how images 1 should be labeled.

In particular, an image 1 can include labels defined in text form (e.g., “list of boxes in the form of [center_x, center_y, width, height]: [0.0, 0.1, 5.1, 6.1], . . . ”). Thus, a lot of images 1 with their manually created labels can be used to condition the instruction model 9.

The image or the images 1 together with their labels 5 and/or with the user command 7 can be fed into the reconstruction loss 19, in particular in order that it includes the ground truth labels or the real labels and/or annotations.

The labeling model 13 can use the (comprehensible), encoded (LVLM) labeling instructions 11, which have been generated by the instruction LVLM or instruction model 9, and the same images 1, which have been used for generating the labeling instructions 11.

The labeling model 13 can output labels for the images 1. In the system, a reconstruction loss 19 for training the instruction LVLM can be implemented. It can compare the manually and automatically generated labels. In particular, it can output a training signal to change the instruction LVLM 9 such that it outputs more precise labeling instructions 11.

Overall, the examples show how an automatic generation of tagging instructions or labeling instructions 11 can be provided by LVLMs 9, 13.

German patent application no. 10 2024 123 825.9, filed Aug. 21, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for automatically generating a labeling instruction for labeling at least one image for a machine labeling model by way of a system that includes a machine instruction model and the machine labeling model each based on pretrained machine vision language models, the method comprising:
a) providing a plurality of images together with associated, manually created labels to the machine instruction model;
b) applying the machine instruction model to the plurality of the images, wherein a labeling instruction is generated for each of the plurality of images;
c) feeding the labeling instruction generated for each of the plurality of images into the machine labeling model and generating, by way of the machine labeling model, an automatically generated label for each of the plurality of images;
d) applying a reconstruction loss that quantifies a discrepancy between the manually created labels and the automatically generated label automatically generated by the machine labeling model for each of the plurality of images, wherein a reconstruction loss value is generated for each image of the plurality of images, wherein the reconstruction loss value generated for each image of the plurality of images serves as a measure of accuracy of the automatically generated label automatically generated by the labeling model for the image;
e) repeating a) to d) until a preset number of training loops and/or a preset reconstruction loss value is reached; and
f) responsive to achieving at least one of the preset number of training loops and/or the preset reconstruction loss value:
b.2) applying the machine instruction model to a new plurality of images without associated labels, wherein a new labeling instruction is generated for each of the new plurality of images; and
c.2) feeding the new labeling instruction generated for each of the new plurality of images into the machine labeling model and generating, by way of the machine labeling model, an automatically generated label for each of the new plurality of images,
wherein b.2) and c.2) are repeated until a termination criterion is satisfied.

2. The method according to claim 1, further comprising:
providing, by the machine instruction model, an interface that receives a user command.

3. The method according to claim 2, further comprising:
setting at least one preset criterion for generating labels based on the user command.

4. The method according to claim 3, wherein setting of the at least one preset criterion includes a selection of:
at least one of multiple preset labeling methods, and/or
at least one of multiple preset labeling categories, and/or
at least one of multiple preset labeling rules that determine when an object is to be annotated.

5. The method according to claim 1, further comprising:
generating an indication for a user of the system in a) and/or in c.2).

6. The method according to claim 1, wherein the plurality of the images include a plurality of lanes, wherein the automatically generated label automatically generated for each of the new plurality of images in c.2 is routed to a driver assistance system, wherein the driver assistance system includes a lane recognition network, wherein the lane recognition network is trained by way of the automatically generated label automatically generated for each of the new plurality of images to recognize the plurality of lanes, and the driver assistance system performs an at least partially automatically realized longitudinal and/or transverse guidance according to the plurality of lanes recognized by way of the lane recognition network trained by way of the automatically generated label automatically generated for each of the new plurality of images.

7. The method according to claim 1, wherein each of the manually created labels associated with the plurality of images includes a text description and/or describes position information and/or a size of a recognized object within one of the plurality of images.

8. The method according to claim 1, wherein the machine instruction model provides the labeling instruction generated for each of the plurality of images in natural language form for a user.

9. The method according to claim 1, further comprising:
using a data criterion which ensures that the plurality of the images together with the manually created labels associated with the plurality of images cover a plurality of scenarios,
wherein a preset number of the plurality of images is respectively captured at different times of day and/or under different weather conditions and/or with varying illumination situations and/or from different perspectives.

10. The method according to claim 1, wherein the automatically generated label automatically generated for each image of the plurality of images includes information regarding one or more recognized objects in the image, including a position and/or size of each of the one or more recognized objects.

11. A control device, comprising:
a processor; and
a memory storing program instructions that, when executed by the processor, cause the control device to:
a) provide a plurality of images together with associated, manually created labels to a machine instruction model;
b) apply the machine instruction model to the plurality of the images, wherein a labeling instruction is generated for each of the plurality of images;
c) feed the labeling instruction generated for each of the plurality of images into the machine labeling model and generate, by way of the machine labeling model, an automatically generated label for each of the plurality of images;
d) apply a reconstruction loss that quantifies a discrepancy between the manually created labels and the automatically generated label automatically generated by the machine labeling model for each of the plurality of images, wherein a reconstruction loss value is generated for each image of the plurality of images, wherein the reconstruction loss value generated for each image of the plurality of images serves as a measure of accuracy of the automatically generated label automatically generated by the labeling model for the image;
e) repeat a) to d) until a preset number of training loops and/or a preset reconstruction loss value is reached; and
f) responsive to achieving at least one of the preset number of training loops and/or the preset reconstruction loss value:
b.2) apply the machine instruction model to a new plurality of images without associated labels, wherein a new labeling instruction is generated for each of the new plurality of images; and
c.2) feed the new labeling instruction generated for each of the new plurality of images into the machine labeling model and generate, by way of the machine labeling model, an automatically generated label for each of the new plurality of images,
wherein b.2) and c.2) are repeated until a termination criterion is satisfied.

12. A backend server device comprising a control device according to claim 11.

13. A system comprising a motor vehicle and a backend server device according to claim 12.
